(19) United States
(12) Patent Application Publication
(10) Pub. No.: US 2008/0225694 A1
(43) Pub. Date: Sep. 18, 2008

(54) METHOD AND APPARATUS FOR ID IDENTIFICATION USING PN FOR TDS-OFDM IN TRANSMISSION

(75) Inventors: Lin Yang, Fremont, CA (US); Qin Liu, Fremont, CA (US)

Correspondence Address: FRANK F. TIAN, 331-4A THIRD AVENUE, LONG BEACH, NJ, 07740, US

(73) Assignee: LEGEND SILICON CORP., FREMONT, CA (US)

(21) Appl. No.: 12/048,307

(22) Filed: Mar. 14, 2008

Related U.S. Application Data
(60) Provisional application No. 60/895,132, filed on Mar. 15, 2007.

(51) Int. Cl. H04J 11/00

(52) U.S. Cl. 370/210

(57) ABSTRACT

In an OFDM system having PN sequences as guard intervals, a method is used for synchronization. The method comprises the steps of: providing a plurality of base stations; providing a plurality of mobile stations; both the base stations and the mobile stations are adapted to transmit and receive signals associated with a parameter using the PN sequences for synchronization.

### CROSS-REFERENCE TO OTHER APPLICATIONS

The following applications of common assignee and filed on the same day herewith are related to the present application, and are herein incorporated by reference in their entireties:

U.S. patent application Ser. No. ______ with attorney docket number LSFFT-034.

U.S. patent application Ser. No. ______ with attorney docket number LSFFT-035.

U.S. patent application Ser. No. ______ with attorney docket number LSFFT-036.

U.S. patent application Ser. No. ______ with attorney docket number LSFFT-038.

U.S. patent application Ser. No. ______ with attorney docket number LSFFT-039.

U.S. patent application Ser. No. ______ with attorney docket number LSFFT-040.

U.S. patent application Ser. No. ______ with attorney docket number LSFFT-041.

### REFERENCE TO RELATED APPLICATIONS

This application claims an invention which was disclosed in Provisional Application No. 60/895,132, filed Mar. 15, 2007 entitled “METHOD AND APPARATUS FOR CELL ID, BS AND SYSTEM PARAMETERS DENTIFICATION USING PN SEQUENCE FOR TDS-OFDM IN TRANSMISSION”. The benefit under 35 USC §119(e) of the United States provisional application is hereby claimed, and the aforementioned application is hereby incorporated herein by reference.

### FIELD OF THE INVENTION

The present invention relates generally to applications relating to TDS-OFDM systems, more specifically the present invention relates to cell ID and system parameters identification for TDS-OFDM system in information transmission.

### BACKGROUND

TDS-OFDM is used in digital TV applications. For mobile station using TDS-OFDM, there is a need for synchronization. Therefore, it is desirous to have system parameters used to assist synchronization, performance monitoring, and handover.

### SUMMARY OF THE INVENTION

In a TDS-OFDM system such as a DMB-TH digital TV application. Multiple BS are used and MS need to know the BS ID and system parameters such as FFT size (single one), to assist synchronization, performance monitoring and handover.

In an OFDM system having PN sequences as guard intervals, a method is used for synchronization. The method comprises the steps of: providing a plurality of base stations; providing a plurality of mobile stations; both the base stations and the mobile stations are adapted to transmit and receive signals associated with a parameter using the PN sequences for synchronization.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example of a communication system in accordance with some embodiments of the invention.

FIG. 2 is an example of a TDS-OFDM symbol with PN guard intervals in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to cell ID and system parameters identification for TDS-OFDM system. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of cell ID and system parameters identification for TDS-OFDM system described herein. The non-processor circuits may include, but are not limited to, a radio receiver, a radio transmitter, signal drivers, clock circuits, power source circuits, and user input devices. As such, these functions may be interpreted as steps of a method to perform cell ID and system parameters identification for TDS-OFDM system. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

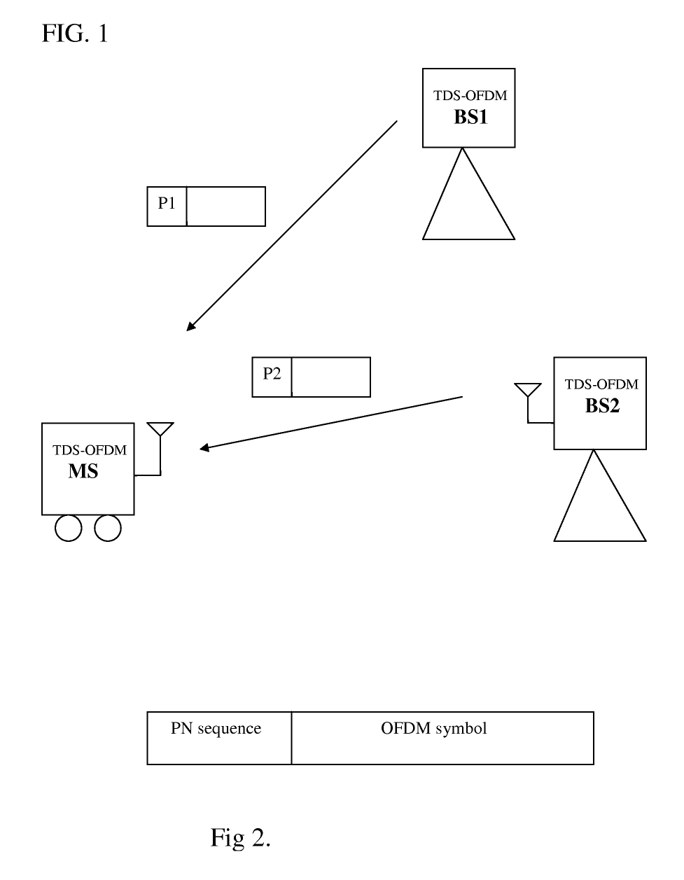

Referring to FIG. 1, a plurality of base stations (BS) are provided (only two shown). Base station (BS1) transmits signals S₁ employing PN sequence P₁. Similarly, base station (BS2) transmits signals S₂ employing PN sequence P₂. Each BS uses different PN codes or each segment in a cell uses different PN codes. Further, BS uses PN code to inform (MS) about transmission parameters such as fast Fourier transform (FFT) size. Mobile station (MS) receives signals from all transmitted signals from base stations including BS1 and BS2. The receiver knows the PN sequences of all transmitted signals from BS1 and BS2 and other BSs. The MS identifies the PN codes from all transmitted BS. The MS knows the BS or segment ID of the received signals and the corresponding parameters such as FFT size. The information from PN codes can further be used for demodulation and hand-off.

Referring specifically to FIG. 2, a packet of transmission or a received packet having PN sequence as guard interval among a plurality of guard intervals (only one shown) is shown. The packet is positioned sequentially within a frame among a multiplicity of packets. As can be appreciated, PNs are disposed between the OFDM symbols. It is noted that the present invention contemplates using the PN sequence disclosed in U.S. Pat. No. 7,072,289 to Yang et al which is hereby incorporated herein by reference.

It is advantageous over other systems in the use of PNs as guard intervals between symbols or data in such systems as TDS-OFDM systems. The advantages include improved channel estimation time, improved synchronization time, and less need to insert more known values such as pilots in what would be used or reserved for data.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” and terms of similar meaning should not be construed as limiting the item described to a given time period or to an item available as of a given time, but instead should be read to encompass conventional, traditional, normal, or standard technologies that may be available now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

What is claimed is:

1. In an OFDM system having PN sequences as guard intervals, a method comprising the steps of:
providing a plurality of base stations;
providing a plurality of mobile stations;
both the base stations and the mobile stations are adapted to transmit and receive signals associated with a parameter using the PN sequences for synchronization. OFDM system is a TDS-OFDM system.

2. The method of claim 1, wherein the parameter is a fast Fourier transform (FFT) size.
